(19) United States
(12) Patent Application Publication
(10) Pub. No.: US 2021/0372198 A1
(43) Pub. Date: Dec. 2, 2021

(54) DOOR, IN PARTICULAR A QUICK-ACTION ROLL-UP DOOR

(71) Applicant: Frinova GmbH, Pansdorf (DE)

(72) Inventor: Wilhelm DÜCK, Lübeck (DE)

(21) Appl. No.: 17/333,855

(22) Filed: May 28, 2021

(30) Foreign Application Priority Data
Jun. 2, 2020 (EP) 20177762.0

(51) Int. Cl. E06B 9/58; F16H 25/24

(52) U.S. Cl. CPC E06B 9/58; E06B 9/68; F16H 25/24

(57) ABSTRACT

A quick-action roll-up door includes a flexible door leaf (6) with a vertical running direction for closing a door opening bordered by a door frame (1). The quick-action roll-up door includes a drive (7) for the opening and closing of the door and a pressing fixture, with which the door leaf in a door leaf closed position can be pressed against the door frame (1).

### CROSS REFERENCE TO RELATED APPLICATIONS

This application claims the benefit of priority under 35 U.S.C. § 119 of European Application 20177762.0, filed Jun. 2, 2020, the entire contents of which are incorporated herein by reference.

### TECHNICAL FIELD

The invention relates to a door, in particular a quick-action roll-up door with a flexible door leaf with a vertical running direction for the closing of a door opening bordered by a door frame and with a drive for opening and closing the door.

### TECHNICAL BACKGROUND

Such doors with a vertical running direction of the door leaf are known in numerous variants of embodiment. In this connection, reference is made to EP 1 760 237 A2, EP 0 816 624 B1 or EP 1 847 673 A1.

### SUMMARY

The invention proceeds from the prior art such as is known from WO 2016/119836 A1. This construction has proved to be very successful, high opening and closing speeds being able to be achieved on account of the comparatively lightweight, but flexible door leaf, which is advantageous in particular for the closing of cold storage rooms or deep-freeze rooms, which on the one hand must allow good accessibility, but on the other hand should be opened only for as short a period as possible on account of the temperature differences between the room interior and the surroundings. It is not only the time in which the door is opened that counts, but in particular also the time in which the door opens and closes again. Access is not guaranteed during this time, but the heat exchange to be avoided is present. It is therefore a constant aim to keep the opening and closing times as short as possible, which can only be achieved in practice with quick-action roll-up doors, which have a comparatively small inherent weight and whose flexible door leaf can be wound up with a vertical running direction.

Especially when used in cold storage rooms or deep-freeze rooms, it is not only a matter of the quick opening and closing of the door, but also of the tight closure. In this regard, it is known to fix the door leaf magnetically to the frame, to guide it in grooves or to provide special seals. A problem here is that with an increasing tightness of the door the forces required for the opening also grow, in order to be able to open the door leaf, which is abutting in a sealing manner against the frame, by winding up.

Such doors, however, often serve not only for the access to the cold storage room, deep-freeze room or suchlike, but also have to meet fire protection regulations. It is then necessary, however, for the tight closure of the closed door to withstand increased temperature and the effect of flames from inside.

Against this background, the problem underlying the invention is to design a door, in particular a quick-action roll-up door of the type mentioned at the outset, in such a way that on the one hand quick opening and closing is possible, but on the other hand a tight closure is guaranteed when the door is closed, which in particular can also meet fire protection regulations.

According to the invention, this problem is solved by a door with feature of the invention. Advantageous embodiments of the invention emerge from this disclosure including the following description and the drawings.

The door according to the invention, in particular a quick-action roll-up door, is one with a flexible door leaf with a vertical running direction. This door is provided for the closing of a door opening bordered by a door frame and comprises a drive for the opening and closing of the door. According to the invention, a pressing fixture is provided, with which the door leaf in its closed position can be pressed against the door frame.

The basic idea of the present invention is to develop a door known in itself and tried and tested, in particular a quick-action roll-up door, such as is used in particular for the closure of cold storage rooms, deep-freeze rooms and suchlike, but also other rooms, by means of a pressing fixture, in such a way that the door in its closed position can be pressed in the direction of the door frame, i.e. in the direction of the interior of the room to be closed, so that extensive and reliable sealing of the closed door, i.e. the door leaf with respect to the door frame, is guaranteed. Such a pressing fixture can be implemented with comparatively easy design effort and can be activated and deactivated rapidly with a suitable design, so that the opening and closing times of the door are thus not substantially lengthened. On the other hand, however, it is possible with a suitable design of the pressing fixture to design such a roll-up door with a flexible door leaf in such a way that the latter can also in particular satisfy fire protection regulations.

The design according to the invention is particularly well suited for quick-action roll-up doors, but can in principle also be used with other doors with a flexible door leaf.

A quick-action roll-up door in the sense of the invention is understood to mean roll-up doors, the door leaf whereof opens and closes with a speed of at least one meter per second.

A flexible door leaf in the sense of the invention is typically understood to mean a door leaf constructed essentially from textile materials, which has a certain inherent stability in order to close the door opening over its area, but on the other hand can be wound up and is preferably constituted such that, in the event of a collision with a forklift truck or another vehicle, the door leaf gives way and then automatically forms back again into the intended plane initial position. In principle, a flexible door leaf in the sense of the present invention can also be a segmented door leaf, but typically textile insulating materials, woven and knitted materials are connected to one another in a suitable material selection and coordination, which have a comparatively high flexibility in the windup direction and lower flexibility in the transverse direction thereto. The materials used are adapted to the intended use, i.e. highly heat-insulating for use in a cold storage or deep-freeze room. When used in fire protection, the latter are optionally also provided in addition with further materials or coatings, which meet the special requirements made on fire protection and fire prevention. In the extreme case, it is a quick-action roll-up door for a deep-freeze room, which in addition also meets the requirements on fire prevention and fire protection, such as they are defined in the relevant standards.

A door in the sense of the present invention is understood to mean a closeable opening. The closure takes place by means of a flexible door leaf with a vertical running direction, which can typically be wound up into a door leaf roll above the door. A door frame in the sense of the invention does not necessarily have to be a separate component, but can represent the boundary of the door opening, if for example the door opening is provided in a concrete wall. The door frame can however also be stabilized and finished with metal or other components. The door according to the invention is typically arranged in such a way that the door leaf extends laterally beyond the door opening or the door frame, a stepped opening can however also be provided, depending on the design, so that the door leaf runs in the region of the door frame inside the door opening.

In order to be able, on the one hand, to have a high degree of flexibility of the door leaf, but on the other hand to be able to guarantee a tight closure of the door leaf with respect to the door frame, the pressing fixture is equipped according to an advantageous development of the invention with a pressing frame, which covers the door leaf in its closed position at least in sections of the two vertically running side regions of the door leaf By means of such an inherently stable pressing frame, the door leaf is as it were clamped and therefore fixed in a force-fit and sealing manner between the pressing frame and the door frame at least at the side regions, and depending on the design optionally also around the entire periphery.

In principle, it is conceivable to operate the pressing frame manually by means of a suitable lever device. In the course of an automated sequence of the opening and closing process of the door that is as rapid as possible, however, it is expedient and advantageous to provide an electric motor driven, pneumatic or hydraulic control that brings this about. Alternatively, the pressing force of the pressing frame can be generated by a spring force, when an electric motor driven, pneumatic or hydraulic control can be provided in a kinematic reversal, in order to move the pressing frame away from the door frame for the purpose of opening and closing the door. The pressing frame can typically be moved linearly or perpendicularly with respect to the door frame, i.e. its distance with respect to the door frame changes all over on the pressing frame in the same way. A suitable bearing can be provided for example in the lateral regions for this purpose. Alternatively, the pressing frame can be arranged in a swivellable manner, wherein the swiveling axis should be close to floor, preferably lying beneath the floor, in order to enable a certain distance of the pressing frame from the door frame also in the lower region for the opening of the door.

It is particularly advantageous if a separate drive for the pressing frame is dispensed with and this drive for the pressing frame takes place via the movement of the door leaf, i.e. by means of the drive that is present anyway for winding up and unwinding of the door leaf.

It can however also be advantageous to provide drive means, with which the pressing frame can be moved and force can be applied thereto in the direction of the door frame. The door leaf, once it has reached its closed position, can thus also not only abut in a tight manner against the door frame by means of the pressing frame, but can also abut in a force-fit manner against the latter by the application of force, which is advantageous especially for fire protection requirements, where, on account of the high temperature and possibly also pressure differences, significantly greater forces can occur, which act on the door leaf and which are ultimately absorbed by the pressing frame.

For reasons of stability, a pressing frame is preferable which is configured closed and thus typically has a rectangular shape and can thus press the door leaf on all four sides, insofar as present, against the door frame. Such an arrangement is especially advantageous for doors in which a conveyor belt for example is provided, which passes through the opened door. If, on the other hand, the door is to be passable or traversable by a stacker lift truck or a forklift truck, then the lower horizontal cross bar of the pressing frame either has to be dispensed with or the latter has to be incorporated into a floor joint, so that it can be traveled over when the door leaf is opened.

The pressing frame can however also be advantageously configured only U-shaped, i.e. comprise two vertically running sections, which are connected to one another by a horizontal section at the upper side. Such a U-shaped pressing frame open towards the bottom will sufficiently fix and press the door leaf in the closed position against the door frame, but in the opened position of the door leaf can be readily traversed.

In order to ensure that the flexible door leaf, which is wound up above the door frame to form a door leaf roll, is always in its intended position with a small distance in front of the door frame during closing, it is advantageous to provide a rotatably mounted guide roll at the upper side of the pressing frame in order to deflect the door leaf. Such a deflection roll is advantageously mounted rotatable inside the pressing fixture horizontally above the horizontal section of the pressing frame. Such a deflection and guide roll can also advantageously be used to guide the movement of the pressing frame through the movement of the door leaf. For this purpose, the door leaf roll should preferably be provided not only above the guide roll, but also with a sufficient vertical spacing from the guide roll and from the door frame, in such a way that, during the rotation of the door leaf roll in the windup direction, a transverse force is exerted in the direction away from the door frame onto the guide roll. This transverse force can be used, during the passage of the door leaf out of the closed position, first to move the pressing frame with the aid of this transverse force out of its pressed on position away from the door frame, in order then to be able subsequently to move the door leaf upwards free from clamping forces and to wind up the latter to form the door leaf roll. Such an arrangement, which is described in detail below, has the advantage that the control of the pressing fixture is guided by the door leaf and therefore by the drive for winding up the door leaf and a separate drive for the pressing fixture is thus not required.

In order to move the pressing frame in an essentially transversely running direction to the closed door leaf, pneumatic cylinders, electric linear drives, hydraulic drives or also piezoelectric drives can alternatively be used, which are active between the door frame and the pressing frame. A drive that has proved to be technically particularly straightforward, reliable and robust is one in which a spindle drive is provided, which is active between the pressing frame and the door frame and by means of which the pressing frame can be moved and a force can be applied thereto towards the door frame.

It is particularly advantageous if at least two spindle drives are provided at both sides of the door leaf, i.e. on the right and the left, in order to reliably press in particular the vertical regions and to hold it in the press-on position in a force-fit manner. Advantageously, however, a plurality of spindle drives are provided, preferably four spindle drives in each case in the corner regions of the pressing frame, which are driven synchronously.

Such a spindle drive always consists of a spindle and a spindle nut, from which one of the components is driven in a rotating manner, in order to produce a movement in the axial direction of the spindle. It is particularly advantageous if the drive spindles are mounted rotatably in the pressing frame and engage in the spindle nuts, which are arranged fixed at the door frame side. Such an arrangement is also advantageous from the production standpoint, since all the components arranged on the frame side can be prefabricated and assembled in the factory, whereas components on the door frame side either have to be integrated into the door frame to the installed separately or have to be fitted on site, which is always more costly from the assembly standpoint.

According to an advantageous development of the invention, a drive motor is provided centrally outside on the pressing frame for the drive of the drive spindles, which drive motor drives all the spindles synchronously. The synchronous drive can take place by means of toothed gearing, a chain gear or in another suitable way, it being particularly advantageous if toothed gearing is used which creates a drive connection between the drive motor and the spindle drives. Such toothed gearing is available at low cost, is smooth-running, has long-term stability and guarantees, on account of the form fit, a synchronous operation of all the spindle drives. For this purpose, on the drive spindles rotatably mounted in the pressing frame, which are arranged with one end in the spindle nuts arranged at the door frame side, toothed gears in the form of spur gears are arranged on the free other end at the rear side, around which spur gears a common toothed belt is looped together with the drive wheel and which are thus driven synchronously by a central drive motor.

The spindle drives are active both in the press-in direction and also in the opposite direction, i.e. move the pressing frame towards the door frame or in the opposite direction, depending on the direction of rotation of the motor, but it is advantageous according to a further development to mount the spindle drives movable to a limited extent in the pressing frame and to provide spring means, which apply force to the pressing frame opposite to the pressing direction. They can advantageously be helical springs, which are arranged surrounding the respective spindle between the drive frame and the spindle nut.

Especially when the drive of the pressing fixture takes place by means of the door leaf drive indirectly via the door leaf, it is advantageous if a spring force can be applied to the pressing fixture not in the opening direction, but in the closing direction, i.e. in the pressing direction towards the door frame. For this purpose, suitable spring means should be provided, for example helical springs in the region of the corner points of the pressing frame, which apply a force to the latter with a spring pretensioning force in the direction towards the door frame. In principle, the spring means can also be formed by other types of spring, such as for example pneumatic springs, torsion bar springs, leaf springs or suchlike.

In order not to load the door leaf with the spring force of the pressing fixture during the entire opening and closing process, a locking mechanism is provided according to an advantageous development of the invention, which keeps the pressing frame at a distance from the door frame and can preferably be activated by control means on the door leaf side. Alternatively, a separate control, for example a pneumatic cylinder or an electric actuator, can also be provided for this purpose. The locking mechanism is expediently arranged and constituted in such a way that it holds the pressing frame at a distance from the door frame until immediately before the closing of the door leaf and is only deactivated when the door leaf has reached its closed position. Such a locking mechanism can advantageously be constituted by a locking lever arranged at the door frame side and to which a spring force is applied towards the locking position, said locking lever being able to be moved out of its locking position by a control element arranged on the door leaf side. Such an arrangement is simple in design and operates reliably. Locking levers are advantageously arranged at both vertical sides of the door frame, which are spring pretensioned and thus automatically arrive in the locking position holding the pressing frame at a distance from the door frame, in which locking position the door leaf can move largely friction-free between the pressing frame and the door frame. Suitable pegs are advantageously provided at the door leaf side, which project laterally out of the door leaf and are arranged such that, immediately before the complete closing of the door leaf, they move the lever out of the locking position, so that the pressing frame presses the door leaf against the door frame controlled by spring force.

The door according to the invention can be arranged particularly advantageously in a cold storage room or a deep-freeze room, since on the one hand it opens and closes very quickly, but on the other hand closes in a sealed manner when the pressing fixture is activated. At the same time or alternatively, the door according to the invention can be constituted as a fire protection door, i.e. apart from the special properties required for a cold storage room or a deep-freeze room, can also satisfy the properties which comply with the special fire protection regulations.

The invention is represented below with the aid of an example of embodiment represented in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partially in cross-sectional side view, in a very simplified diagrammatic representation, of a first embodiment of a door according to the invention;

FIG. 2 is a front view of the door according to FIG. 1;

FIG. 3 is an enlarged detail view showing detail III in FIG. 1;

FIG. 4 is a partially in cross-sectional side view, in a very simplified diagrammatic representation, of the door according to the invention;

FIG. 5 is a front view of the door according to FIG. 4;

FIG. 6 is an enlarged side view of the locking mechanism in the locking position; and

FIG. 7 is a view showing the locking mechanism according to FIG. 6 in the released position.

### DESCRIPTION OF PREFERRED EMBODIMENTS

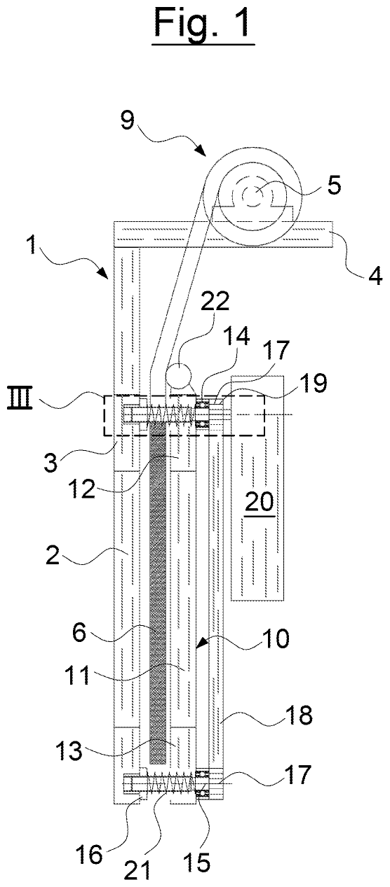

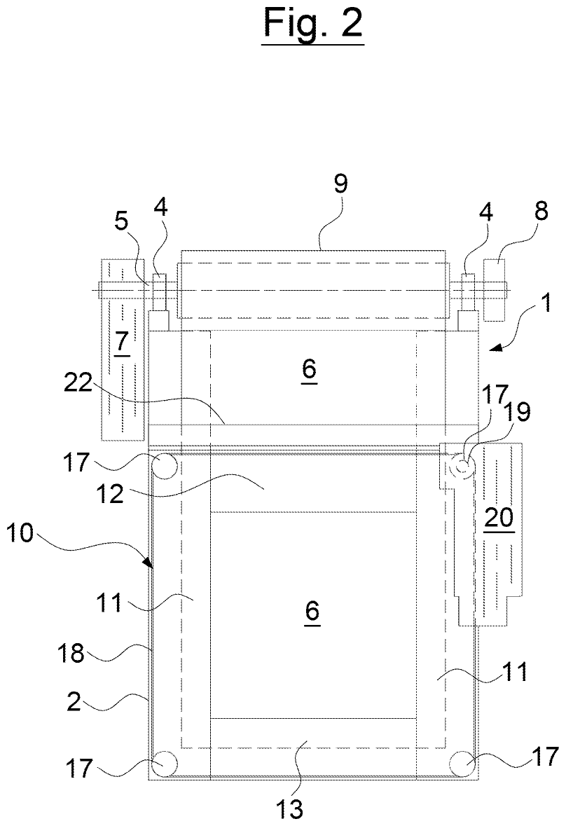

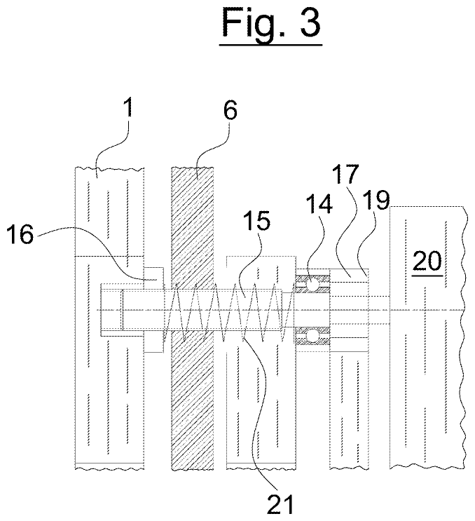

Referring to the drawings, the quick-action roll-up door represented in FIGS. 1-3 comprises a door frame 1, which closed off and completely surrounds a door opening in a wall of a room to be closed off to the exterior by the door, said door frame not being represented in detail here. Door frame 1 represented here in detail can also be formed by the door opening itself, if the corresponding components are fitted or constituted directly there.

The door frame 1 comprises two vertically arranged frame parts 2 laterally bordering the door opening, which are connected to one another at the upper side by a lintel-like support 3 and which together determine the clearance profile of the opening. Vertical frame parts 2 adjoin supports 4 arranged at right angles thereto and projecting into the free space in front of the door, between which supports a shaft 5 is mounted, on which a door leaf 6 can be wound up or unwound. For this purpose, a drive 7 is provided at one end of shaft 5 beyond support 4, which is not described in detail here, and at the other side a braking device 8, which ensures that shaft 5 of door leaf roll 9 is fixed in the event of failure of the drive.

Door leaf 6 is made of a flexible material, is formed in an extensive manner and has a width which overlaps somewhat vertical frame parts 2 of door frame 1. By a suitable operation of the drive 7, door leaf roll 9 can be unwound, so that door leaf 6 is arranged in front of door frame 1 closing the door opening, as is represented in FIG. 1. This is the closed position of the door. By operating drive 7 in the opposite direction, door leaf 6 can be pulled upwards out of the closed position represented in FIG. 1 and wound up onto door leaf roll 9, in which the opening of door frame 1 is freed, this being the opened position.

In order to press door leaf 6 in its closed position towards door frame 1 and thus to be able to place it against the latter in a force-fit manner, a pressing fixture is provided. This pressing fixture comprises a rectangular pressing frame 10, which can be moved at a distance from door frame 1 in the direction towards the latter and away from the latter, but can also be arranged fixed. This pressing frame 10 is arranged aligned with door frame 1 and overlaps or surrounds the door opening formed in door frame 1 by a distance, in such a way that door leaf 6 in the closed position is overlapped laterally by two vertical sections 11 and at the upper and lower side of frame 10 by two horizontal sections 12 and 13.

Pressing frame 10 is provided in its corner regions with bearings 14, in which spindles 15 are arranged rotatably, which engage in spindle nuts 16 arranged aligned with spindles 15 on the door frame side and together with the latter form spindle drives. At the other, in FIG. 1, outer and right-hand end of spindles 15, spur gears 17 are arranged non-rotatably on spindles 15, which, by means of a circulating toothed belt, are coupled in a mobile manner with one another and with a spur gear 19 of an electric drive device 20. Electric drive device 20 is fixed to pressing frame 10 and controlled by a central control, which controls the closing and opening process of the door. In the embodiment represented, drive device 20 directly drives a spindle 15, but it can also engage in a driving manner in toothed belt 18 at another point by means of its spur gears 9.

Pressing frame 10 is mounted with axial play by means of spindles 15. Spindles 15 are in each case surrounded by a helical spring 21, which is arranged pretensioned between spindle nut 16 and the side of pressing frame 10 pointing towards door frame 1, in such a way that springs 21 exerts a restoring force on the pressing frame in the restoring or opening direction.

In order that door leaf 6, independently of the roll position and therefore the thickness of door leaf roll 9, always runs in the region of door frame 1 parallel to the latter, a guide roll 22 is mounted freely rotatable at the upper side of pressing frame 10, which guide roll feeds the door leaf from door leaf roll 9 towards door frame 1.

The function of the previously described door is as follows. Proceeding from an opened position, in which door leaf 6 is arranged with its lower side roughly in the region of guide roll 22 and moreover is rolled up on door leaf roll 9, drive 7 is activated in the closing direction in order to close the door, as a result of which shaft 5 carrying the door leaf roll is moved in the unwinding direction, until the door leaf is located in its position closing door frame 1 to the exterior, i.e. on the right-hand side in FIG. 1, in which position vertical frame parts 2 and the components connecting the latter transversely at the lower side and at the upper side of door leaf 6 are overlapped. In this position (closed position), electric drive device 20 is activated, in such a way that the four spindles 15 mounted rotatably in the corner regions of pressing frame 10 are driven synchronously, so that the latter rotate into spindle nuts 16 and move pressing frame 10 in the direction towards door frame 1, until the latter abuts against the door frame 1 including the lateral door leaf parts, the lower end and an upper cross-section and, with further operation of the drive, abuts on this frame 1 with an applied force and therefore seals door leaf 6 with respect to door frame 1. In this position, the door is not only closed, but also sealed off.

For the subsequent opening, electric drive device 20 is first operated in the opposite direction, as a result of which spindles 15 rotate in the opposite direction, pressing frame 10 is thus moved away from door frame 1, helical springs 21 serving to adjust the required restoring forces.

As soon as pressing frame 10 is so far removed from door frame 1 that door leaf 6 is freely mobile between door frame 1 and pressing frame 10, drive 7 is again activated, this time in the opposite direction, after which door leaf 6 is wound up until the end of door leaf 6 is located in the region of the upper transverse section of pressing frame 10 or of upper horizontal frame part 3 of door frame 1.

In the embodiment represented and described above, pressing frame 10 is constituted closed, which is particularly advantageous with regard to the pressing forces thus created and the tightness of door leaf 6 with respect to door frame I. This means however that both pressing frame 10 and also door frame 1 comprise a lower horizontal support. The latter, when the door is to be suitable for driving through, have to be integrated into the floor, or the pressing frame has to be constituted U-shaped, i.e. constituted without lower horizontal section 13. Toothed belt 18 then has to be guided correspondingly U-shaped, since the lower transverse connection is absent. The lower horizontal frame part of the door frame is then also absent. In the closed position, door leaf 3 is then fixed only at three sides, at the bottom side it merely abuts in a sealing manner.

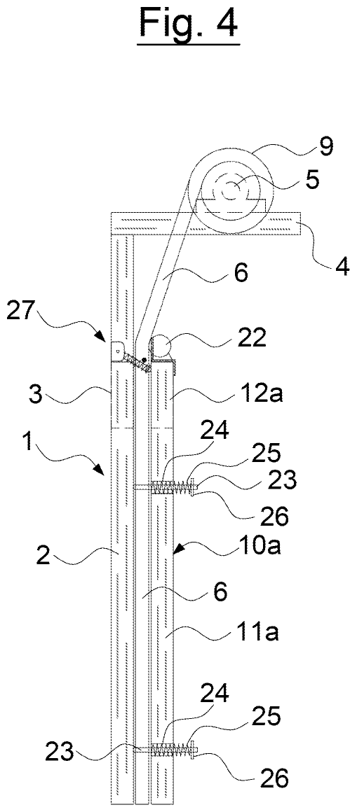

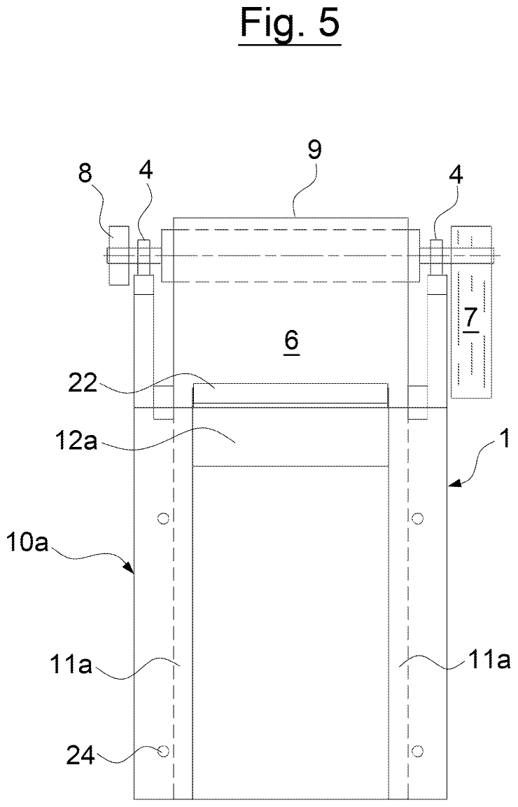

In the variant of embodiment described with the aid of FIGS. 4 to 7, the basic structure of the door is identical, i.e. a door 1 with vertical frame parts 2 and a horizontal support 3 comprises two supports 4 projecting horizontally in the room, which support a shaft 5 for winding up a door leaf 6. A drive 7 is arranged at one side of shaft 5, at the other side a braking device 8. Door leaf 6 closing door frame 1 is wound up to form a door leaf roll 9 on shaft 5 in the opened position. In the closed position, in which door leaf 6 closes door frame 1, the latter can be pressed by a pressing fame 10a against door frame 1 in order to guarantee a tight fit.

Pressing frame 10a is constituted in the same way as the previously described one, it comprises vertical sections 11a and a horizontal section 12a connecting the latter at the upper side and can be moved in the direction towards door frame 1 and away from the latter. For this purpose, a total of four bolts 23 fitted on the door frame side essentially in the corner regions of pressing frame 10a are provided, which are guided through holes 24 provided in pressing frame 10a. Bolts 23 are surrounded by helical springs 25, which abut with the one side against pressing frame 10a and their other side abuts against a disc 26, which is fastened to the free end of respective bolt 23. Springs 25 are pretensioned, so that their spring force acts on pressing frame 10a.

In this embodiment, the pressing force of pressing frame 10a is created by the spring force of helical springs 25. A drive is thus required here, which moves pressing frame 10a away from door frame 1 so that door leaf 6 can move freely between pressing frame 10a and door frame 1. The drive mechanism required for this is formed by drive 7 of shaft 5 via door leaf roll 9 to door leaf 6.

The door leaf, as shown in particular in FIG. 4, is guided at the upper side of pressing frame 10a by means of guide roll 22. Since door leaf roll 9 sits not only above pressing frame 10a, but also at a vertical distance therefrom, and to be precise in the direction away from door frame 1, a force component arises on guide roll 22 during the winding up of door leaf 6, said force component being directed away from door frame 1, i.e. in the opposite direction to the pressing direction of helical screws 25, apart from the upwardly directed component for pulling up door leaf 6. This force component is used in this embodiment in order to move pressing frame 10a against the force of helical screws 25 in the direction away from door frame 1.

Since this force component is available only during the opening and diminishes with an increasing degree of opening, a locking mechanism 27 is provided between door frame 1 and pressing frame 10a. This locking mechanism consists of two locking levers 28 arranged in a swivellable manner on door frame 1 at the side of door leaf 6 and two pegs 29 projecting laterally on door leaf 6, which can enter into an active connection with these locking levers 28.

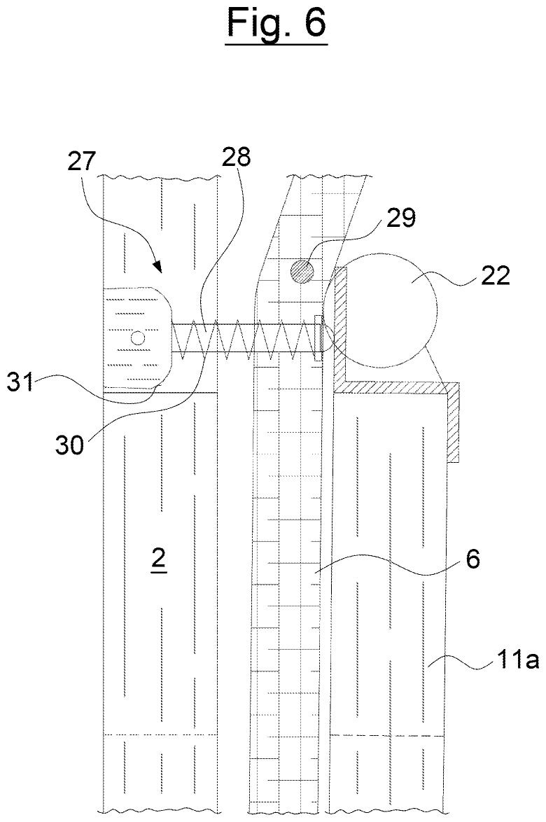

Locking levers 28 are arranged not only in a swivellable manner on the door frame side, but pretensioned in the direction of their locking position by a helical screw 30 surrounding them. Each helical screw is on the one hand supported on the end of the respective locking lever and abuts on the other hand against a link 31, which is constituted such that each locking lever 28 is automatically brought into its essentially horizontal locking position by the pressing force of helical springs 30, which is represented in FIG. 6. In this position, the free lever end supports pressing frame 10a so far that door leaf 6 can be moved with play between pressing frame 10a and door frame 1. This position represented in FIG. 6 essentially serves for the low-friction opening and closing of the door. Since pressing frame 10a is guided by bolts 23 and can only move linearly, locking levers 28 arranged on both sides of door leaf 6 lock the free space formed between door frame 1 and pressing frame 10a over the entire area of the frame.

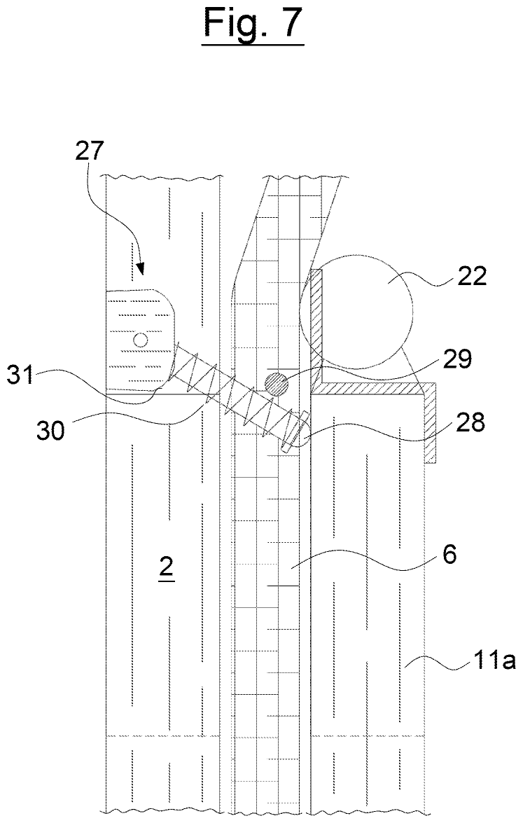

Pegs 29 are arranged on door leaf 6 in such a way that the latter, during closing of door leaf 6, i.e. during the unwinding of door leaf 6 into its closed position, collide with locking levers 28 when the lower end of door leaf 6 has almost reached the closing end position. Locking levers 28 are then swiveled downwards into the position represented in FIG. 7 by pegs 29 against the spring force of helical springs 30, in which position the locking effect is removed and pressing frame 10a is pressed by the force of helical springs 25.

In the opposite direction for the opening, drive 7 is activated, as a result of which shaft 5 with door leaf 6 partially wound up thereon in the open position exerts a torque, which is transmitted to door leaf 6 in the form of a tensile force. A force component acting in the horizontal direction thus also arises on guide roll 22, which force component pulls pressing frame 10a out of the pressing-on position into the opened position spaced apart, in which door leaf 6 can be freely moved. In this position, locking levers 28 automatically swivel back into the locking position represented in FIG. 6 due to the spring force of helical springs 30, in which the pressing mechanism of helical screws 25 is blocked, as soon as the door leaf is pulled up so far that pegs 29 release locking levers 28.

In the example of embodiment represented, pressing frame 10a can be moved only linearly. Instead of the linear mobility, pressing frame 10a can be linked in a swivellable manner at the underside of the frame, preferably underneath the floor, so that the guides between bolts 23 and holes 24 can then be subject to play.

While specific embodiments of the invention have been shown and described in detail to illustrate the application of the principles of the invention, it will be understood that the invention may be embodied otherwise without departing from such principles.

### LIST OF REFERENCE NUMBERS

1 door frame
2 vertical frame parts
3 horizontal support of door frame
4 horizontal support of door frame projecting into the room
5 shaft
6 door leaf
7 drive
8 braking device
9 door leaf roll
10, 10a pressing frames
11, 11a vertical sections of the pressing frame
12, 12a horizontal upper section of the pressing frame
13 horizontal lower section of the pressing frame
14 bearing in the pressing frame
15 spindles
16 spindle nuts in the door frame
17 spur gears at the end of spindles 15
18 circulating toothed belt
19 spur gear of the electric drive device
20 electric drive device
21 helical springs
22 guide roll
23 bolts
24 holes
25 helical screws
26 discs
27 locking mechanism
28 locking bar
29 pegs
30 helical springs
31 link

What is claimed is:

1. A quick-action roll-up door comprising:
a flexible door leaf with a vertical running direction for the closing of a door opening bordered by a door frame;
a drive for opening and closing the door; and
a pressing fixture configured to press the door leaf, in a door leaf closed position, towards the door frame.

2. The door according to claim 1, wherein:
the door leaf has two vertically running door leaf side regions;
the pressing fixture comprises a pressing frame which covers the door leaf in the door leaf closed position at least in sections of the two vertically running door leaf side regions of the door leaf.

3. The door according to claim 2, further comprising drive means configured to move the pressing frame and to apply a force in a direction of the door frame or to apply a force in a direction opposite to the direction of the door frame or to apply a force in a direction of the door frame and in a direction opposite to the direction of the door frame.

4. The door according to claim 2, wherein:
the pressing frame comprises at least one horizontal section, which connects two vertically running sections at a top; and
the pressing frame is mounted swivellable about an axis adjacent to the floor or linearly movable.

5. The door according to claim 2, wherein the pressing frame is formed with an open region at a lower side thereof.

6. The door according to claim 2, wherein:
the pressing fixture comprises a pressing frame;
the pressing frame comprises a rotatably mounted guide roll for deflecting the door leaf, wherein the guide roll is at a pressing frame upper side; and
the door leaf roll is provided above the guide roll such that, during a rotation of the door leaf roll in a wind-up direction, a transverse force is exerted in a direction away from the door frame onto the guide roll.

7. The door according to claim 2, wherein the pressing frame is moveable and is configured to receive an applied force thereto towards the door frame by means of a spindle drive.

8. The door according to claim 2, wherein:
the pressing frame is moveable; and
at least two spindle drives are arranged in respective corner regions of the pressing frame and are driven synchronously.

9. The door according to claim 7, wherein
the spindle drive comprises drive spindles mounted rotatably in the pressing frame;
the drive spindles engage in spindle nuts arranged on a door frame side; and
the drive spindles are drive-connected to a drive motor provided centrally outside on the pressing frame.

10. The door according to claim 9, wherein a toothed belt drive-connects the drive motor to the spindle drives.

11. The door according to claim 8, wherein:
the spindle drives are mounted movable to a limited extent in the pressing frame; and
a spring means applies force to the pressing frame opposite to the pressing direction.

12. The door according to claim 7, wherein:
the spindle drive comprises a drive spindle;
a helical spring surrounds the drive spindle and has a force action between door frame and the pressing frame.

13. The door according to claim 2, wherein spring means apply a force to and press the pressing frame in the direction of the door frame.

14. The door according to claim 2, further comprising a locking mechanism which maintains the pressing frame at a distance from the door frame and is activatable by a control means on a door leaf side.

15. The door according to claim 14, wherein the locking mechanism comprises at least one locking lever arranged at the door frame side and to which a spring force is applied towards a locking position, said locking lever being moveable out of the locking position by a control element arranged on the door leaf side.

16. The door according to claim 1, wherein the door leaf is configured as insulating for use in a cold storage room or a deep-freeze room and/or as a fire protection door.

17. The door according to claim 16, wherein the door leaf comprises a segmented and/or textile door leaf, which can be wound up into a door leaf roll on an outside above the door frame.
